(19) United States
(12) Patent Application Publication
(10) Pub. No.: US 2023/0252554 A1
(43) Pub. Date: Aug. 10, 2023

(54) REMOVING SEMANTIC DUPLICATES FROM RESULTS BASED ON SIMILARITY BETWEEN EMBEDDINGS FOR DIFFERENT RESULTS

(71) Applicant: Maplebear Inc. (dba Instacart), San Francisco, CA (US)

(72) Inventors: Taesik Na, Issaquah, WA (US); Esther Vasiete, Brooklyn, NY (US)

(21) Appl. No.: 17/669,192

(22) Filed: Feb. 10, 2022

(51) Int. Cl. G06Q 30/06; G06Q 10/08; G06K 9/62; G06F 16/9535

(52) U.S. Cl. CPC G06Q 30/0635; G06Q 10/0875; G06K 9/6215; G06K 9/623; G06F 16/9535

(57) ABSTRACT

An online concierge system displays a search interface to users. When displaying suggestions for a query, or displaying results, the online concierge system retrieves candidate suggestions and ranks the candidate suggestions. The online concierge system also obtains an embedding for each candidate suggestion. The online concierge system determines measures of similarity between embeddings for different pairs of candidate suggestion. If a candidate suggestion in a pair has at least a threshold measure of similarity to the other candidate suggestion in the pair, the online concierge system removes one of the candidate suggestions from the pair when displaying candidate suggestions. The online concierge system may remove a candidate suggestion having a lower position in the ranking in a pair of candidate suggestions.

### BACKGROUND

This disclosure relates generally to generating results for a query, and more specifically to removing results for the query having embeddings with at least a threshold measure of similarity to other results for the query.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in a user's order in a warehouse and deliver the items included in the order to a location specified by the user.

To simplify identification and inclusion of items in an order, conventional online concierge systems use one or more autocompletion, or autosuggestion, methods to simplify entry of search queries by users. In conventional autocompletion methods, characters entered into a search bar or other interface elements form a prefix, and an interface displayed by the online concierge system displays suggestions for extending the prefix to a full search query. The suggestions displayed by the interface are ranked. Conventional autocompletion methods typically mine logs of previously received search queries and order the displayed suggestions based on frequencies of occurrence of different search queries.

However, previously received queries may include multiple queries that have similar, or identical, semantic meanings. Hence, displaying suggestions for completing a query based on previously received queries often displays multiple suggestions to a user that have similar semantic meanings, displaying an increased number of unnecessary suggestions to a user. This increases an amount of time for the user to identify a suggestion relevant to a prefix of the search query that the user has provided. Further, many online concierge systems limit display of suggestions for a search query to a limited number of suggestions, such as 10 suggestions. Selecting multiple suggestions with similar semantic meanings limits an amount of diversity in the suggestions that are displayed to a user, which may inefficiently use limited display space on certain devices, such as mobile devices.

### SUMMARY

When an online concierge system receives a request for an order from a user, the online concierge system transmits an interface including a search interface to a client device of the user. The search interface receives a prefix comprising set of characters from the user through an input element. The online concierge system selects one or more suggestions that each include one or more terms to suggest to the user based on the prefix and displays the selected one or more suggestions to the user via the search interface, allowing the user to select a displayed suggestion as terms to include in a query, reducing an amount of inputs by the user for the online concierge system to receive a query. When displaying suggestions to a user, the online concierge system ranks the suggestions and displays the suggestions in the search interface in an order based on the ranking.

In response to receiving a query from the user via the search interface for a search for the requested order, the online concierge system selects a set of candidate suggestions based on the query. In some embodiments, the online concierge system selects candidate suggestions that each include one or more terms at least partially matching a prefix of the query. The online concierge system ranks the candidate suggestions based on one or more criteria. For example, the online concierge system applies a trained model to a combination of the prefix and a candidate suggestion that determines a probability of the user selecting the candidate suggestion in response to the online concierge system having received the prefix. The online concierge system applies the trained model to each candidate suggestion and ranks the candidate suggestions based on their corresponding probabilities of being selected in response to the online concierge system receiving the prefix. In other embodiments, the online concierge system applies a trained conversion model to a combination of the received prefix, a warehouse identified with the received prefix, and a candidate suggestion to determine a probability of the user performing a specific interaction after selecting in response to selecting the candidate suggestion and ranks the candidate suggestions based on their corresponding probabilities.

For each candidate suggestion, the online concierge system obtains an embedding that represents a candidate suggestion in a latent space. In some embodiments, the online concierge system obtains an embedding for a subset of the candidate suggestions. For example, the online concierge system identifies candidate terms having at least a threshold position in the ranking and obtains an embedding for each identified candidate suggestion of the set. In various embodiments, when the online concierge system receives a query, the online concierge system applies one or more trained models to generate an embedding corresponding to the query from the terms included in the query. In some embodiments, the online concierge system may store the embedding in association with the received query, allowing the online concierge system to generate embeddings from previously received queries. Example models for generating an embedding include a next token prediction model, a masked language model, a next sentence prediction model, a permutation language model, and a replaced token detection model. In other instances, other models may be applied to a suggestion to generate an embedding for the suggestion.

The online concierge system selects a candidate suggestion from the set and determines measures of similarity between an embedding for the selected candidate suggestion and embeddings for other candidate suggestions with higher positions in the ranking. In some embodiments, the measure of similarity is a dot product between the embedding of the selected candidate suggestion and the embedding of the other candidate suggestion having a higher position in the ranking than the selected candidate suggestion. As another example, the measure of similarity is a cosine similarity between the embedding of the selected candidate suggestion and the embedding of the other candidate suggestion having a higher position in the ranking than the selected candidate suggestion.

In response to determining that a measure of similarity between the embedding for the selected candidate suggestion and an embedding for another candidate suggestion having a higher position in the ranking than the selected candidate suggestion equals or exceeds a threshold value, the online concierge system removes the selected candidate suggestion from the set of candidate suggestions. When the online concierge system removes the selected candidate suggestion from the set, the online concierge system increases positions in the ranking of candidate suggestions with lower positions in the ranking than the selected candidate suggestion. Hence, the online concierge system modifies the set of candidate embeddings with the selected candidate embedding when the measure of similarity between the embedding for the selected candidate suggestion and the embedding for another candidate suggestion having a higher position in the ranking than the selected candidate suggestion equals or exceeds a threshold value, indicating the selected candidate suggestion and the other suggestion are semantic duplicates.

The online concierge system transmits, to a client device of the user from whom the prefix was received, at least a subset of the modified set of the selected candidate suggestions with the selected candidate suggestion removed; the client device displays the selected candidate suggestions received from the online concierge system to the user via an interface, such as the search interface described above. In some embodiments, the online concierge system transmits the modified set of the selected candidate suggestions without the selected candidate suggestion, while in other embodiments, the online concierge system selects a subset of the modified set of the candidate suggestions based on one or more criteria and transmits the subset of the modified set to the client device for display via the interface. For example, the online concierge system transmits candidate suggestions of the modified set that have at least a threshold position in the ranking to the client device for display via the interface. If the online concierge system removes the selected candidate suggestion in response to the embedding for the selected candidate suggestion having at least the threshold measure of similarity to the embedding for the other candidate suggestion having the higher position in the ranking than the selected candidate suggestion, the online concierge system modifies the ranking by increasing positions of candidate suggestions that were lower than the selected candidate suggestion and transmits the modified set of the selected candidate suggestions based on the modified ranking. Hence, when the selected candidate suggestion is removed from the ranking, an alternative candidate suggestion is included in the modified ranking and transmitted rather than the selected candidate suggestion. For example, the alternative candidate suggestion is a candidate suggestion having a position in the ranking that is one position below the position in the ranking of the selected candidate suggestion.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is an example of a search interface of a customer mobile application (CMA), according to one embodiment.

FIG. 5 is a flowchart of a method for an online concierge system filtering suggestions for completing a search query based on similarities between embeddings for different suggestions, according to one embodiment.

FIG. 6 is a process flow diagram of one embodiment of a method for an online concierge system filtering suggestions for completing a query based on similarities between embeddings for different suggestions, according to one embodiment.

FIG. 7 is a block diagram of a system environment in which an online system, such an online concierge system, operates, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

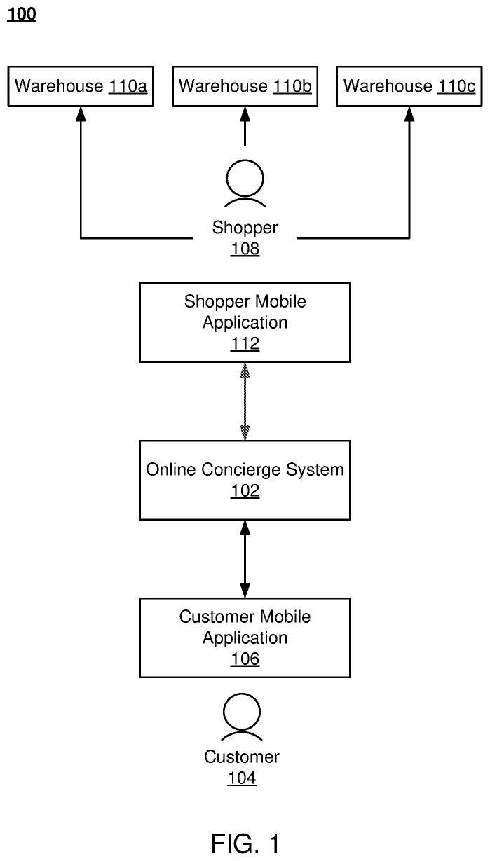

FIG. 1 illustrates an environment 100 of an online platform, according to one embodiment. The figures use like reference numerals to identify elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

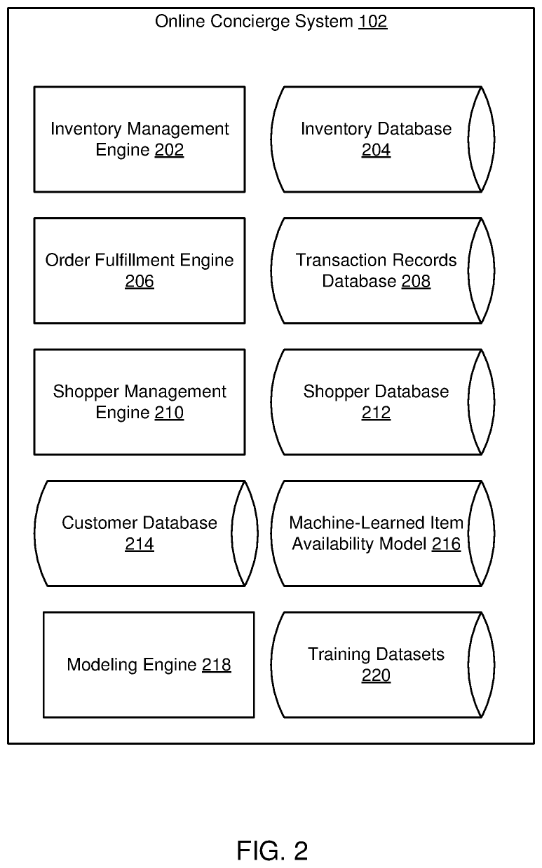

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

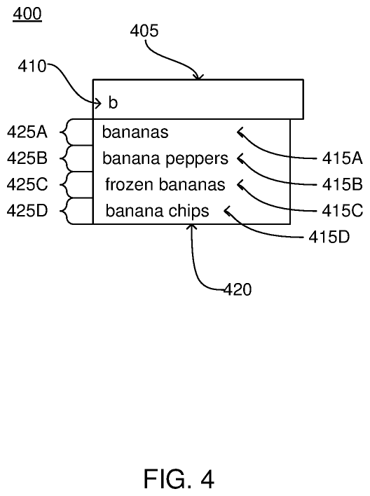

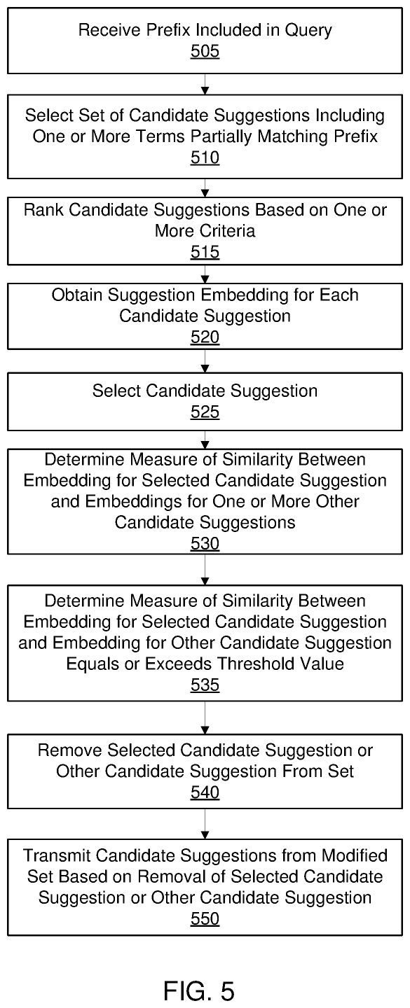

In various embodiments, the order fulfillment engine 206 generates and transmits a search interface, such as the search interface described below in conjunction with FIG. 4, to a client device of a user for display via the customer mobile application 106. The order fulfillment engine 206 receives a prefix, comprising a set of characters, from the user via the search interface and identify a set of terms for a search query based on the prefix. In various embodiments, the terms selected by the order fulfillment engine include the prefix or include a portion of the prefix. In various embodiments, the order fulfillment engine 206 displays multiple terms to the user as suggestions for completing a search query corresponding to a received prefix and determines an order in which the terms are displayed via the customer mobile application 106. As further described below in conjunction with FIG. 5, when determining an order in which to display the terms, the order fulfillment engine 206 accounts for probabilities of the user including an item corresponding to different terms in an order. Hence, in various embodiments, the order fulfillment engine 206 displays terms in an order where terms corresponding to terms having higher probabilities of being included in an order have higher positions in the order, increasing visibility of those terms to the user via the customer mobile application 106.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220.

Additionally, in various embodiments the training datasets 220 include training data describing orders previously received from users and prior searches of items offered by various warehouses 110. For example, training data identifies a prefix received for a search, a suggestion selected for the search, and a warehouse 110 for which the search was received. As another example, the training data identifies a prefix received for a search, a suggestion selected for the search, a warehouse 110 for which the search was received, and information describing an order received subsequent to the search (e.g., items included in the order, a number of items included in the order, etc.). The prior searches and previously received orders allow the online concierge system 102 to determine an order in which to display terms as suggestions for a search that accounts for frequencies or likelihoods of items corresponding to different terms being included in an order after a search is received, as further described below in conjunction with FIG. 5.

The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a trained conversion model that determines a probability of a user including an item corresponding to a suggestion in an order when the suggestion is displayed. In various embodiments, the conversion model receives a combination of a warehouse 110, a term, and a prefix received in a prior search, as well as a set of features for the combination from prior searches received from users for the warehouse 110 that include the prefix and previously received orders for items that include an item corresponding to the term. As further described below in conjunction with FIG. 5, the distance prediction model accounts for prior inclusion of items in orders from the warehouse that were received after searches including various terms were received, providing a probability of a user including an item in an order after the user inputs a search including a term. This allows the online concierge system 102 to account for effects of different terms in searches on subsequent inclusion of items in orders when determining an order in which to present terms to a user, allowing such presentation of terms to more prominently display terms with higher probabilities of the user subsequently including an item in an order.

### Machine-Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

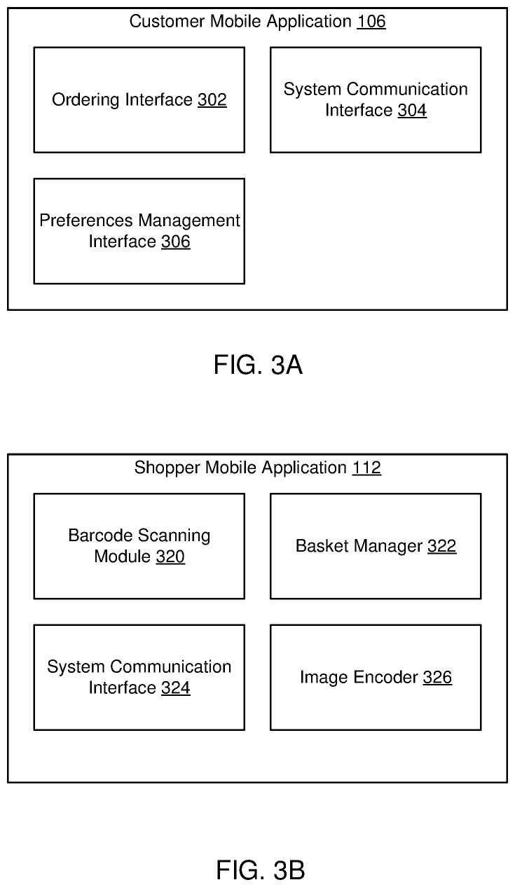

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

In various embodiments, the ordering interface 302 includes a search interface configured to receive a search query from a user. The online concierge system 102 identifies one or more items satisfying the received search query and displays information about the identified items to the user via the CMA 106, allowing the user to more easily identify items offered by a warehouse 110. To simplify entry of a search query, the online concierge system 102 displays suggestions of terms for the search query to the user as the online concierge system 102 receives portions of terms comprising the search query, allowing the user to select a suggestion to provide a search query by selecting a suggestion.

FIG. 4 is one example of a search interface 400 of a customer mobile application (CMA) 106. In various embodiments, the search interface 400 is displayed in conjunction with additional content, so the search interface 400 comprises a portion of a larger interface displayed by the CMA 106. However, in other embodiments, the search interface 400 is an independent interface displayed by the CMA 106.

The search interface 400 includes an input element 405, such as a search bar, configured to receive text input from a user. Text entered into the input element 405 by the user forms a prefix 410 that is a set of one or more characters received from the user. The prefix 410 is updated as the input element 405 receives text, so the prefix 405 is adjusted or modified as the user provides input to the input element 405. The online concierge system 102 identifies one or more terms 415A, 415B, 415C, 415D (also referred to individually and collectively using reference number 415) based on the received prefix 410. The search interface 400 displays the terms 415 in a suggestion region 420 configured to receive user input. An input to the suggestion region 420 allows the user to select a suggestion 415, which replaces the prefix 410 in the input element 410 with the suggestion 415 selected by the user. This allows the online concierge system 102 to simplify user entry of a search query by allowing the user to select a suggestion 415 from the suggestion region 420 rather than manually enter the suggestion 415 in its entirety.

The suggestion region 420 includes different positions 425A, 425B, 425C, 425D (also referred to individually and collectively using reference number 425) in which suggestions 415 are displayed. Each position 425 displays a single suggestion 415, and the online concierge system 102 determines ranking for the suggestions 415 and displays the suggestions 415 so a position 425 in the suggestion region 420 for the suggestion corresponds to a position in the ranking for the suggestion 415. As further described below in conjunction with FIG. 5, the online concierge system 102 filters the suggestions 415 displayed in the suggestion region 420 by accounting for measures of similarities between embeddings for different suggestions 415. This allows the suggestion region 420 to more efficiently use available display space by limiting display of suggestions 415 having greater than a threshold measure of similarity to each other, allowing the suggestion region 420 to display suggestions 415 that are more semantically varied relative to each other.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from system 102 and transmits the contents of a basket of items to system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Filtering Suggested Terms for Queries Based on Measures of Similarity Between Queries

FIG. 5 is a flowchart of one embodiment of a method for an online concierge system 102 filtering suggestions for completing a query based on similarities between embeddings for different suggestions. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

As further described below in conjunction with FIG. 5, the method selects a suggestion and identifies additional suggestions that are semantic duplicates of the suggestion from measures of similarity between an embedding for the suggestion and embeddings. The online system removes one or more suggestions that are semantic duplicates of another suggestion, allowing display of the suggestions to more efficiently use a display area while displaying suggestions in the display area having greater semantic diversity. For purposes of illustration, FIG. 5 shows removal of semantic duplicates from suggestions that are identified in response to the online system receiving a query, while in other embodiments the online system may identify the suggestions based on other criteria.

To simplify creation of an order by a user, when an online concierge system 102 receives a request for an order from a user, the online concierge system 102 transmits an interface including a search interface, as further described above in conjunction with FIG. 4, to a client device of the user. The search interface receives a prefix comprising a set of characters from the user through an input element, such as the search bar shown in FIG. 4. The online concierge system 102 selects one or more suggestions that each include one or more terms to suggest to the user based on the prefix and displays the selected one or more suggestions to the user via the search interface. This allows the user to select a displayed suggestion as terms to include in a query, reducing an amount of inputs by the user for the online concierge system 102 to receive a query. When displaying suggestions to a user, the online concierge system 102 ranks the suggestions and displays the suggestions in the search interface in an order based on the ranking. To determine the ranking of the suggestions for display to the user, the online concierge system 102 leverages previously received queries and previously received interactions.

In response to receiving 505 a prefix for a query from the user via the search interface for a search for the requested order, the online concierge system 102 selects 510 a set of candidate suggestions based on the query. In some embodiments, the online concierge system 102 selects 510 suggestions having one or more terms that at least partially match the prefix as the set of candidate suggestions. In various embodiments, the online concierge system 102 selects 510 a candidate suggestion as a previously received query including the prefix. In some embodiments, the online concierge system 102 receives 505 the prefix as well as a selection of a warehouse 110, and the online concierge system 102 selects 510 one or more candidate suggestions as category or other information from a taxonomy including the prefix or a name of an item obtained from an item catalog of the identified warehouse 110.

The online concierge system 102 ranks 515 the candidate suggestions based on one or more criteria. For example, the online concierge system 102 applies a trained model to a combination of the prefix and a candidate suggestion that determines a probability of the user selecting the candidate suggestion in response to the online concierge system 102 having received the prefix. The online concierge system 102 applies the trained model to each candidate suggestion and ranks 515 the candidate suggestions based on their corresponding probabilities of being selected in response to the online concierge system 102 receiving the prefix. In other embodiments, the online concierge system 102 applies a trained conversion model to a combination of the received prefix, a warehouse 110 identified with the received prefix, and a candidate suggestion to determine a probability of the user performing a specific interaction after selecting in response to selecting the candidate suggestion. The online concierge system 102 ranks 515 the candidate suggestions based on their corresponding probabilities. However, in other embodiments, the online concierge system 102 ranks 515 the candidate suggestions based on any suitable criteria.

In some embodiments, to rank 515 the candidate suggestions, the online concierge system 102 trains a conversion model that outputs a probability of a user performing a specific interaction after selecting a suggestion when a prefix has been received. The online concierge system 102 generates training data for the conversion model comprising a plurality of examples. Each example includes a combination of a suggestion and a term, and may include other information, such as a warehouse 110 or other features of the combination of the suggestion and the term. Each example of the training data is labeled with an indication of whether the specific interaction (e.g., inclusion of an item corresponding to the suggestion in an order) was performed after the suggestion was selected after the prefix was received by the online concierge system 102. The online concierge system 102 applies the conversion model to each of a plurality of examples of the training data. For an example of the training data, application of the conversion model to the example generates a predicted probability of a user performing the specific interaction after selecting the suggestion when the online concierge system 102 received the prefix. The online concierge system 102 determines an error term from a difference between the label applied to the example of the training data and the predicted probability of a user performing the specific interaction after selecting the suggestion when the online concierge system 102 received the prefix. The error term may be generated through any suitable loss function, or combination of loss functions, in various embodiments. For example, the loss function is a mean squared error between a predicted probability of a user performing the specific interaction after selecting the suggestion when the online concierge system 102 received the prefix for an example of the training data and a label applied to the corresponding example of the training data. However, in other embodiments, any loss function or combination of loss functions, may be applied to the predicted probability of a user including an item corresponding to the suggestion in an order for an example and the label applied to the corresponding example of the training data to generate the error term.

The online concierge system 102 backpropagates the one or more error terms from the label applied to an example of the training data and the predicted probability of a user performing the specific interaction after selecting the suggestion when the online concierge system 102 received the prefix through layers of a network comprising the conversion model. One or more parameters of the network are modified through any suitable technique from the backpropagation of the one or more error terms through the layers of the network. For example, weights between nodes of the network, such as nodes in different layers of the network, are modified to reduce the one or more error terms. The backpropagation of the one or more error terms is repeated by the online concierge system 102 until the one or more loss functions satisfy one or more criteria. In some embodiments, the online concierge system 102 uses gradient descent or any other suitable process to minimize the one or more error terms in various embodiments. In response to the one or more loss functions satisfying the one or more criteria and the online concierge system 102 stopping the backpropagation of the one or more error terms, the online concierge system 102 stores the set of parameters for the layers of the network as the conversion model. Training of a conversion model is further described in U.S. patent application Ser. No. 17/478,411, filed on Sep. 17, 2021, which is hereby incorporated by reference in its entirety

For each candidate suggestion, the online concierge system 102 obtains 520 an embedding that represents a candidate suggestion in a latent space. In some embodiments, the online concierge system 102 obtains 520 an embedding for a set of candidate suggestions. For example, the online concierge system 102 selects a set of candidate terms having at least a threshold position in the ranking and obtains 520 an embedding for each candidate suggestion of the set. In various embodiments, when the online concierge system 102 receives a query, the online concierge system 102 applies one or more trained models to generate an embedding corresponding to the query from the terms included in the query. In some embodiments, the online concierge system 102 may store the embedding in association with the received query, allowing the online concierge system 102 to generate embeddings from previously received queries. Example models for generating an embedding include a next token prediction model, a masked language model, a next sentence prediction model, a permutation language model, and a replaced token detection model; however, any suitable model may be applied to a suggestion to generate an embedding for the suggestion.

In other embodiments, the online concierge system trains a search relevance embedding model comprising multiple layers that outputs a measure of relevance of a query and an item from prior interactions by users with items. For example, the search relevance embedding model receives a query and an item as inputs, so the online concierge system 102 generates training data including a plurality of examples, with each example including a query and an item. A label is applied to each example indicating whether a user performed a specific interaction with the item after providing the query to the online concierge system. For an example of the training data, application of the search relevance embedding model to the example generates a predicted probability of a user performing the specific interaction with the item after providing the query to the online concierge system 102. The online concierge system 102 determines an error term from a difference between the label applied to the example of the training data and the predicted probability of the user performing the specific interaction with the item after providing the query to the online concierge system 102. The error term may be generated through any suitable loss function, or combination of loss functions, in various embodiments. For example, the loss function is a mean squared error between a predicted probability of a user performing the specific interaction with the item of an example after providing the query of the example to the online concierge system 102 and a label applied to the corresponding example of the training data. However, in other embodiments, any loss function or combination of loss functions, may be applied to the predicted probability of a user performing the specific interaction with an item of an example after providing the online concierge system 102 with the query included in the example and the label applied to the corresponding example of the training data to generate the error term.

The online concierge system 102 backpropagates the one or more error terms from application of the search relevance embedding model to an example of the training data through layers of a network comprising the conversion model. One or more parameters of the network are modified through any suitable technique from the backpropagation of the one or more error terms through the layers of the network. For example, weights between nodes of the network, such as nodes in different layers of the network, are modified to reduce the one or more error terms. The backpropagation of the one or more error terms is repeated by the online concierge system 102 until the one or more loss functions satisfy one or more criteria. In some embodiments, the online concierge system 102 uses gradient descent or any other suitable process to minimize the one or more error terms in various embodiments. In response to the one or more loss functions satisfying the one or more criteria and the online concierge system 102 stopping the backpropagation of the one or more error terms, the online concierge system 102 stores the set of parameters for the layers of the network as the search relevance embedding model. Weights between a pair of layers in the search relevance embedding model are retrieved as an embedding for a query in various embodiments.

The online concierge system 102 selects 525 a candidate suggestion from the ranking and determines 530 measures of similarity between an embedding for the selected candidate suggestion and embeddings for other candidate suggestions. In some embodiments, the online concierge system 102 selects a group of the candidate suggestions based on the ranking. For example, the online concierge system 102 determines 530 measures of similarity between an embedding for the selected candidate suggestion and embeddings for one or more other candidate terms with higher positions in the ranking. In some embodiments, the measure of similarity is a dot product between the embedding of the selected candidate suggestion and the term embedding of the other candidate suggestion having a higher position in the ranking than the selected candidate suggestion. As another example, the measure of similarity is a cosine similarity between the embedding of the selected candidate suggestion and the embedding of the other candidate suggestion having a higher position in the ranking than the selected candidate suggestion. However, in other embodiments, any suitable measure of similarity between embeddings corresponding to a pair of candidate suggestions may be determined 530.

In response to determining 535 a measure of similarity between the embedding for the selected candidate suggestion and an embedding for another candidate suggestion having a higher position in the ranking than the selected candidate suggestion equals or exceeds a threshold value, the online concierge system 102 removes 540 the selected candidate suggestion from the set of candidate suggestions. In other embodiments, the online concierge system 102 removes 540 the selected candidate suggestion from the ranking in response to the measure of similarity between the embedding for the selected candidate suggestion and the embedding for the other candidate suggestion having the higher position in the ranking than the selected candidate suggestion exceeding the threshold value. Hence, the online concierge system 102 removes 540 the selected candidate suggestion or the other candidate suggestion based on relative positions of the candidate suggestion and the other candidate suggestion to each other in the ranking. When the online concierge system 102 removes 540 the selected candidate suggestion form the set, the online concierge system 102 increases positions in the ranking of candidate suggestions with lower positions in the ranking than the selected candidate suggestion. Hence, the online concierge system 102 generates a modified ranking that maintains relative rankings of the remaining candidate suggestions to each other from the ranking.

In some embodiments, to determine 535 whether a measure of similarity between the embedding for the selected candidate suggestion and an embedding for another candidate suggestion having a higher position in the ranking than the selected candidate suggestion equals or exceeds a threshold value, the online concierge system 102 generates multiple pairs of candidate suggestions. In some embodiments, the online concierge system 102 generates each pair of selected candidate suggestions. In other embodiments, the online concierge system 102 identifies a set of selected candidate suggestions having at least a threshold position in the ranking and generates each pair of candidate suggestions included in the identified set. The online concierge system 102 determines a measure of similarity between the embeddings for the candidate suggestions included in the pair. Hence, for a pair including a first candidate suggestion and a second candidate term, the online concierge system 102 determines a measure of similarity between a first embedding for the first candidate suggestion and a second embedding for the second candidate suggestion, as further described above. In some embodiments, the online concierge system 102 stores the determined measure of similarity in association with each corresponding pair. In other embodiments, the online concierge system 102 compares a measure of similarity determined for a pair to the threshold value and stores an indication that the measure of similarity between candidate suggestions in a pair equals or exceeds the threshold value in association with the pair in response to the measure of similarity determined for the pair equaling or exceeding the threshold value. When the online concierge system 102 selects 525 a candidate suggestion, the online concierge system 102 retrieves pairs of candidate suggestions that include the selected candidate suggestion and a candidate suggestion having a higher position in the ranking than the selected candidate suggestion. In response to a pair including the selected candidate suggestion and a candidate suggestion having a higher position in the ranking being associated with the indication that the measure of similarity between candidate suggestions in a pair equals or exceeds the threshold value, the online concierge system 102 removes 540 the selected candidate suggestion from the set of candidate suggestions, as further described above.

The online concierge system 102 transmits 545 at least a subset of the modified set of the selected candidate suggestions with the selected candidate suggestion removed 540 to a client device for display to a user from whom the prefix was received. In various embodiments, the client device displays the subset of the modified set of the selected candidate suggestions via a user interface, such as the search interface further described above in conjunction with FIG. 4. In some embodiments, the online concierge system 545 transmits the modified set of the selected candidate suggestions without the selected candidate suggestion, while in other embodiments, the online concierge system 102 selects a subset of the modified set of the candidate suggestions based on one or more criteria and transmits the subset of the modified set to the client device for display via the interface. For example, the online concierge system 102 transmits 545 candidate suggestions of the modified set that have at least a threshold position in the ranking to the client device for display via the interface. If the online concierge system 102 removes 540 the selected candidate suggestion in response to the embedding for the selected candidate suggestion having at least the threshold measure of similarity to the embedding for the other candidate suggestion having the higher position in the ranking than the selected candidate suggestion, the online concierge system 102 modifies the ranking by increasing positions of candidate suggestions that were lower than the selected candidate suggestion and transmits 545 the modified set of the selected candidate suggestions based on the modified ranking. Hence, when the selected candidate suggestion is removed 540 from the ranking, an alternative candidate suggestion is included in the modified ranking and transmitted 545 rather than the selected candidate suggestion. For example, the alternative candidate suggestion is a candidate suggestion having a position in the ranking that is one position below the position in the ranking of the selected candidate suggestion.

While FIG. 5 described the method as being performed by an online concierge system 102, the method described in conjunction with FIG. 5 may be executed by any online system maintaining items or suggestions that selects items or suggestions for display to remove items or suggestions with embeddings having at least a threshold measure of similarity to an embedding for another item or suggestion. For example, an online system, such as the online concierge system 102, maintains a taxonomy including categories associated with different items. The online system generates an embedding for each category and determines measures of similarities between embeddings for different pairs of embeddings. The online system removes a category from the taxonomy when a measure of similarity between an embedding for the category and an embedding for a different category has at least a threshold value, allowing the online system to remove semantic duplicates from the taxonomy to simplify association of items with categories in the taxonomy.

As another example, an online system recommends content items to a user and generates embeddings for each content item, as further described above. For example, the content items are retrieved by an online system as results for a query, so the content items include content that at least partially matches one or more terms in the query. In another embodiment, the content items are retrieved by an online system as suggestions for terms to include in a query and may be retrieved before the online system receives a prefix for the query. As another example, the content items are selected by the online system based on prior interactions by a user with other content items (e.g., a content item is a recipe including multiple ingredients retrieved by an online concierge system 102 based on items that a user has previously purchased from the online concierge system). The online system identifies a set of content items and may rank the content items based on any suitable criteria, as further described above in conjunction with FIG. 4. Measures of similarity between an embedding for a content item and embeddings for additional content item are determined by the online system, which removes an additional content item with an embedding having at least a threshold measure of similarity to an embedding of the content item. In some embodiments, the online system selects a content item and identifies embeddings for items within a threshold distance of the embedding for the selected item in the latent space of the embeddings using one or more nearest neighbor models or approximate nearest neighbor models and identifies the content items corresponding to the identified embeddings. The online system determines a measure of similarity between the embedding for the selected item and embeddings for one or more of the identified content items. As further described above, the online system may account for the ranking of content items when removing a content item; for example, the online system removes the additional content item with the embedding having at least the threshold measure of similarity to the embedding of the content item from the set in response to the content item having a higher position in the ranking than the additional content item. Removing content items having embeddings with at least the threshold measure of similarity to a content item having a higher position in a ranking allows the online system to display a greater diversity of content items, while simplifying selection of a content item by a user by reducing a number of displayed content items that are semantically similar to each other. In other embodiments, the online system determines a probability of a user performing a specific interaction with a selected content item and a probability of the user performing a specific interaction with an identified content item; when the measure of similarity of the embedding for the selected content item and the embedding for the identified content item equals or exceeds the threshold value, the online system removes the selected content item from the set in response to the probability of the user performing the specific interaction being less than the probability of the user performing the specific interaction with the identified content item. The online system transmits a subset of the content items determined from a modified set with content items having embeddings with at least the threshold measure of similarity to another content item of the set removed to a client device for display. Additionally or alternatively, the online system stores the modified set of content items.

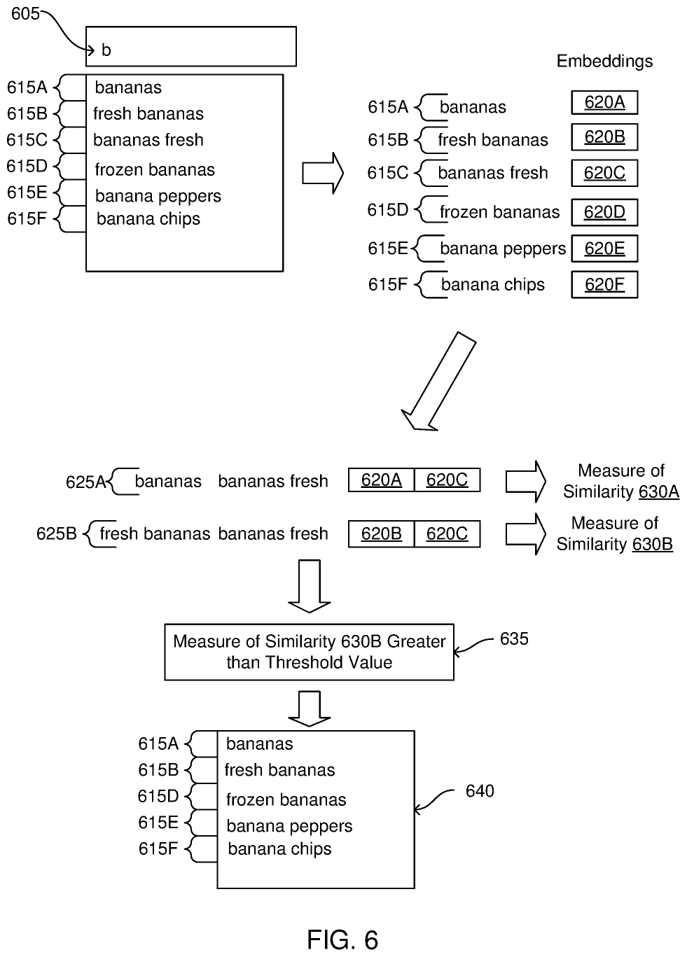

FIG. 6 is a process flow diagram of one embodiment of a method for an online concierge system 102 filtering suggestions for completing a query based on similarities between embeddings for different suggestions. In the example shown by FIG. 6, the online concierge system 102 receives a prefix 605 from a user via a search interface, such as the search interface further described above in conjunction with FIG. 4. Based on the received prefix 605, the online concierge system 102 identifies candidate terms 615A-F (also referred to individually and collectively using reference number 615). As further described above in conjunction with FIG. 4, the online concierge system 102 may identify the candidate terms 615 based on probabilities of a user selecting the candidate terms 615 after providing the prefix 605 to the online concierge system, based on probabilities of the user performing a specific interaction with an item corresponding to a candidate suggestion 615, or based on any other suitable criteria. In various embodiments, the online concierge system 102 ranks the candidate terms 615. For example, a higher position in the ranking corresponds to a higher probability of a user selecting a candidate suggestion 615 or a higher probability of the user performing the specific interaction with an item corresponding to the candidate suggestion 615. Referring to FIG. 6, in one embodiment, a user has a highest probability of performing the specific interaction with an item corresponding to candidate suggestion 615A and a lowest probability of performing the specific interaction with an item corresponding to candidate suggestion 615F.

The online concierge system 102 maintains an embedding 620A-F (also referred to individually and collectively using reference number 620) for each of the candidate suggestions 615A-F. In the example of FIG. 6, embedding 620A corresponds to candidate suggestion 615A, while embedding 620B corresponds to embedding 620B. The online concierge system 102 retrieves an embedding 620A-F corresponding to each of the candidate suggestions 615A-F.

As further described above in conjunction with FIG. 5, the online concierge system 102 generates pairs of different candidate suggestions 615A-F. In some embodiments, the online concierge system 102 generates each pair of candidate suggestions 615A-F, while in other embodiments, the online concierge system 102 leverages a ranking of the candidate suggestions 615A-F when generating pairs of different candidate suggestions 615A-F. In the example of FIG. 6, the online concierge system 102 uses a ranking of candidate suggestions 615 to generate pairs of candidate suggestions by selecting a candidate suggestion 615A-F and generating pairs that include a candidate suggestion 615 and an additional candidate suggestion 615 having a higher position in the ranking. In the example shown by FIG. 6, the online concierge system 102 selects candidate suggestion 615C and generates pair 625A including candidate suggestion 615C and candidate suggestion 620A, which has a higher position in the ranking than candidate suggestion 615C. Similarly, in FIG. 6, the online concierge system 102 generates pair 625B including candidate suggestion 615C and candidate suggestion 620B, which has a higher position in the ranking than candidate suggestion 615C.

For each pair, the online concierge system 102 generates a measure of similarity between embeddings 620 corresponding to candidate suggestions 615 in the pair. The measure of similarity may be a dot product of the embeddings 620 corresponding to candidate suggestions 615 in the pair or a cosine similarity of the embeddings 620 corresponding to candidate suggestions 615 in the pair in some embodiments, while in other embodiments any suitable measure of similarity between the embeddings 620 corresponding to candidate suggestions 615 in the pair may be determined. For purposes of illustration, FIG. 6 shows measure of similarity 630A determined between candidate suggestion 620A and candidate suggestion 620C for pair 625A and measure of similarity 630B determined between candidate suggestion 620B and candidate suggestion 620C for pair 625B.

The online concierge system 102 compares measure of similarity 630A and measure of similarity 630B to a threshold value, as further described above in conjunction with FIG. 5. In the example shown in FIG. 6, this comparison determines 635 that measure of similarity 630B equals or exceeds (or exceeds) the threshold value, indicating that candidate suggestion 615B and candidate suggestion 615C are semantic duplicates based on the measure of similarity between their corresponding embeddings. To more efficiently use a portion of an interface displaying candidate suggestions 615 to a user, the online concierge system 102 removes one of a pair of candidate suggestions 615 determined to be semantic duplicates. In the example of FIG. 6, the online concierge system 102 removes candidate suggestion 615B or candidate suggestion 615C from the candidate suggestions in response to determining 635 that measure of similarity 630B equals or exceeds (or exceeds) the threshold value. When the candidate suggestions 615 are ranked, the online concierge system 102 removes a candidate suggestion 615 having a lower position in the ranking from a pair of candidate suggestions 615 determined to be semantic duplicates. In the example of FIG. 6, candidate suggestion 615C has a lower position in the ranking of candidate suggestions than candidate suggestion 615B, so the online concierge system 102 removes candidate suggestion 615C from the candidate suggestions 615, generating a modified set 640 of candidate suggestions 615.

When a candidate suggestion 615 is removed, the online concierge system 102 increases positions in the ranking of candidate suggestions 615 having positions in the ranking below the removed candidate suggestion 615 in some embodiments. In the example shown by FIG. 6, candidate suggestion 615D is included in the position of the ranking that was previously occupied by candidate 615C. Similarly, positions in the ranking of candidate suggestions 615 below the position of candidate suggestion 615D are similarly increased. By removing semantic duplicates from the candidate suggestions 615, positions of other candidate suggestions 615 that are less similar to other candidate suggestions 615 are increased in a ranking, allowing a greater range of candidate suggestions 615 to be displayed in a given display area. This more efficiently allocates a portion of a user interface for displaying candidate suggestions 615 by allowing the portion of the interface to display candidate suggestions 615 having greater semantic diversity. Additionally, removing semantic duplicates from the candidate suggestions 615 reduces an overall number of candidate suggestions 615 that are displayed, allowing a user to more easily identify and to select a candidate suggestion 615.

### System Architecture

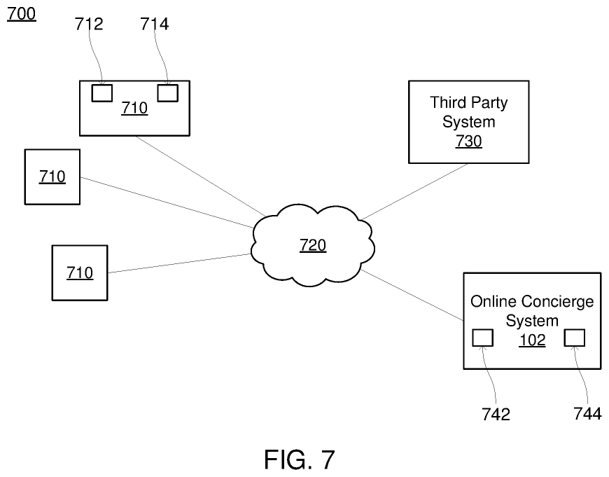

FIG. 7 is a block diagram of a system environment 700 in which an online system, such as the online concierge system 102 further described above in conjunction with FIGS. 1 and 2, operates. The system environment 700 shown by FIG. 7 comprises one or more client devices 710, a network 720, one or more third-party systems 730, and the online concierge system 102. In alternative configurations, different and/or additional components may be included in the system environment 700.

The client devices 710 are one or more computing devices capable of receiving user input as well as transmitting and/or receiving data via the network 720. In one embodiment, a client device 710 is a conventional computer system, such as a desktop or a laptop computer. Alternatively, a client device 710 may be a device having computer functionality, such as a personal digital assistant (PDA), a mobile telephone, a smartphone, or another suitable device. A client device 710 is configured to communicate via the network 720. In one embodiment, a client device 710 executes an application allowing a user of the client device 710 to interact with the online concierge system 102. For example, the client device 710 executes a customer mobile application 106 or a shopper mobile application 112, as further described above in conjunction with FIGS. 3A and 3B, respectively, to enable interaction between the client device 710 and the online concierge system 102. As another example, a client device 710 executes a browser application to enable interaction between the client device 710 and the online concierge system 102 via the network 720. In another embodiment, a client device 710 interacts with the online concierge system 102 through an application programming interface (API) running on a native operating system of the client device 710, such as IOS® or ANDROID™.

A client device 710 includes one or more processors 712 configured to control operation of the client device 710 by performing functions. In various embodiments, a client device 710 includes a memory 714 comprising a non-transitory storage medium on which instructions are encoded. The memory 714 may have instructions encoded thereon that, when executed by the processor 712, cause the processor to perform functions to execute the customer mobile application 106 or the shopper mobile application 112 to provide the functions further described above in conjunction with FIGS. 3A and 3B, respectively.

The client devices 710 are configured to communicate via the network 720, which may comprise any combination of local area and/or wide area networks, using both wired and/or wireless communication systems. In one embodiment, the network 720 uses standard communications technologies and/or protocols. For example, the network 720 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 620 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 620 may be represented using any suitable format, such as hypertext markup language (HTML) or extensible markup language (XML). In some embodiments, all or some of the communication links of the network 720 may be encrypted using any suitable technique or techniques.

One or more third party systems 730 may be coupled to the network 720 for communicating with the online concierge system 102 or with the one or more client devices 710. In one embodiment, a third party system 730 is an application provider communicating information describing applications for execution by a client device 710 or communicating data to client devices 710 for use by an application executing on the client device. In other embodiments, a third party system 730 provides content or other information for presentation via a client device 710. For example, the third party system 730 stores one or more web pages and transmits the web pages to a client device 710 or to the online concierge system 102. The third party system 730 may also communicate information to the online concierge system 102, such as advertisements, content, or information about an application provided by the third party system 730.

The online concierge system 102 includes one or more processors 742 configured to control operation of the online concierge system 102 by performing functions. In various embodiments, the online concierge system 102 includes a memory 744 comprising a non-transitory storage medium on which instructions are encoded. The memory 744 may have instructions encoded thereon corresponding to the modules further described above in conjunction with FIG. 2 that, when executed by the processor 742, cause the processor to perform the functionality further described above in conjunction with FIGS. 2 and 4-6. For example, the memory 744 has instructions encoded thereon that, when executed by the processor 742, cause the processor 742 to identify a content item (e.g., a suggestion) for display to a user, identify additional content items that are semantic duplicates for the identified content item based on embeddings for the identified content item and for the additional content items, and remove one or more of the semantic duplicates from display to the user, as further described above in conjunction with FIGS. 4-6. Additionally, the online concierge system 102 includes a communication interface configured to connect the online concierge system 102 to one or more networks, such as network 720, or to otherwise communicate with devices (e.g., client devices 710) connected to the one or more networks.

One or more of a client device, a third party system 730, or the online concierge system 102 may be special purpose computing devices configured to perform specific functions, as further described above in conjunction with FIGS. 2-6, and may include specific computing components such as processors, memories, communication interfaces, and/or the like.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online concierge system, a query;
selecting a set of candidate suggestions based on the query;
ranking the candidate suggestions based on one or more criteria;
obtaining an embedding for each candidate suggestion of the set of candidate suggestions, the embedding for a candidate suggestion representing the candidate suggestion in a latent space;
selecting a first candidate suggestion of the set of candidate suggestions;
determining a measure of similarity between an embedding for the first candidate suggestion and embeddings for one or more additional candidate suggestions of the set of candidate suggestions;
responsive to determining the measure of similarity between the embedding for the first candidate suggestion and an embedding for an additional candidate suggestion equals or exceeds a threshold value, generating a modified set of candidate suggestions by removing either the selected candidate suggestion or the additional candidate suggestion from the set; and
transmitting a subset of candidate suggestions from the modified set of candidate suggestions to a client device for display based on the ranking.

2. The method of claim 1, wherein determining the measure of similarity between the embedding for the first candidate suggestion and embeddings for one or more additional candidate suggestions of the set of candidate suggestions comprises:
determining a measure of similarity between the embedding for the first candidate suggestion and embeddings for additional candidate suggestions selected based on the ranking.

3. The method of claim 1, wherein generating the modified set of candidate suggestions by removing either the first candidate suggestion or the additional candidate suggestion from the set comprises:
removing either the first candidate suggestion or the additional candidate suggestion from the set based on positions of the first candidate suggestion and of the additional candidate suggestion in the ranking.

4. The method of claim 3, wherein generating the modified set of candidate suggestions by removing either the first candidate suggestion or the additional candidate suggestion from the set further comprises:
generating a modified ranking in response to the removal with remaining candidate suggestions having relative rankings to each other in the modified ranking matching relative rankings of the remaining candidate suggestions to each other in the ranking.

5. The method of claim 1, wherein the measure of similarity comprises a dot product.

6. The method of claim 1, wherein transmitting the subset of candidate suggestions from the modified set to the client device to display based on the ranking comprises:
transmitting candidate suggestions of the modified set having at least a threshold position in the ranking to the client device.

7. The method of claim 1, wherein transmitting the subset of candidate suggestions from the modified set to the client device to display based on the ranking for selection as terms included in the query comprises:
transmitting the modified set of candidate suggestions to the client device.

8. The method of claim 1, wherein ranking the candidate suggestions based on one or more criteria comprises:
ranking the candidate suggestions based on predicted probabilities of a user performing a specific interaction in response to selecting different candidate suggestions.

9. The method of claim 1, wherein ranking the candidate suggestions based on one or more criteria comprises:
ranking the candidate suggestions based on likelihoods of the user selecting each candidate suggestion.

10. The method of claim 1, wherein selecting the set of candidate suggestions based on the query comprises:
selecting candidate suggestions including terms at least partially matching a prefix of the query for the set of candidate suggestions.

11. A method comprising:
retrieving, at an online system, a set of content items for display to a user via an interface;
obtaining, at the online system, an embedding for each content item of the set, the embedding for an item representing the content item in a latent space;
selecting a content item of the set;
determining a measure of similarity between an embedding for the selected content item and an embedding for an additional content item;
modifying the set of items by removing the selected content item or the additional content item from the set in response to the measure of similarity between the embedding for the selected content item and the embedding for the additional content item equaling or exceeding a threshold value; and
storing the modified set of content items at the online system.

12. The method of claim 11, further comprising:
transmitting a subset of the content items of the modified set to a client device for display to a user via the interface.

13. The method of claim 11, wherein determining the measure of similarity between the embedding for the selected content item and an embedding for the additional content item comprises:
identifying embeddings for one or more content items within a threshold distance of the embedding for the selected content item in the latent space;
identifying a content item corresponding to an identified embedding; and
determining the measure of similarity between the embedding for the selected content item and the embedding of the identified content item.

14. The method of claim 11, wherein modifying the set of items by removing the selected content item or the additional content item from the set in response to the measure of similarity between the embedding for the selected content item and the embedding for the additional content item equaling or exceeding a threshold value comprises:
removing the selected content item from the set in response to a probability of a user performing a specific interaction with the additional content item exceeding a probability of the user performing the specific interaction with the selected content item.

15. The method of claim 11, wherein modifying the set of items by removing the selected content item or the additional content item from the set in response to the measure of similarity between the embedding for the selected content item and the embedding for the additional content item equaling or exceeding a threshold value comprises:
obtaining a ranking of the content items based on one or more criteria; and
removing the selected content item from the set in response to the selected content item having a lower position in the ranking than the additional content item.

16. The method of claim 15, wherein the ranking of the content items is based on probabilities of a user performing a specific interaction with the content items.

17. The method of claim 11, wherein modifying the set of items by removing the selected content item or the additional content item from the set in response to the measure of similarity between the embedding for the selected content item and the embedding for the additional content item equaling or exceeding a threshold value further comprises:
increasing a position in the ranking of an alternative content item that is below a position in the ranking of the selected content item to the position of the selected content item.

18. The method of claim 11, wherein content items of the set comprise terms for inclusion in a query.

19. The method of claim 18, wherein retrieving, at an online system, the set of content items for display to the user via the interface comprises:
retrieving, by the online system, the set of content items before the online system receives a prefix for the query.

20. A computer program product comprising a non-transitory computer readable storage medium having instructions encoded thereon that, when executed by a processor, cause the processor to:
retrieve, at an online system, a set of content items for display to a user via an interface;
obtain, at the online system, an embedding for each content item of the set, the embedding for an item representing the content item in a latent space;
select a content item of the set;
determine a measure of similarity between an embedding for the selected content item and an embedding for an additional content item;
modify the set of items by removing the selected content item or the additional content item from the set in response to the measure of similarity between the embedding for the selected content item and the embedding for the additional content item equaling or exceeding a threshold value; and
store the modified set of content items at the online system.
